(19) United States
(12) Patent Application Publication
(10) Pub. No.: US 2026/0074650 A1
(43) Pub. Date: Mar. 12, 2026

(54) Dispatchable Plug-In Power Canopy Appliance for Virtual Power Plant Integration and Community Choice Aggregation

(71) Applicants: Antonia Ginsberg-Klemmt, Sarasota, FL (US); Achim Ginsberg-Klemmt, Sarasota, FL (US)

(72) Inventors: Antonia Ginsberg-Klemmt, Sarasota, FL (US); Achim Ginsberg-Klemmt, Sarasota, FL (US)

(21) Appl. No.: 19/391,301

(22) Filed: Nov. 17, 2025

Related U.S. Application Data
(63) Continuation-in-part of application No. 19/350,425, filed on Oct. 6, 2025.
Application No. 19/350,425 is a continuation-in-part of application No. 18/750,705, filed on Jun. 21, 2024.
Application No. 18/750,705 is a continuation-in-part of application No. 18/348,989, filed on Jul. 7, 2023, now Pat. No. 12,231,083.
Application No. 18/348,989 is a continuation-in-part of application No. 17/981,065, filed on Nov. 4, 2022, now Pat. No. 12,040,737.
Application No. 17/981,065 is a continuation-in-part of application No. 17/326,687, filed on May 21, 2021, now Pat. No. 11,515,833.

(51) Int. Cl. H02S 30/20; E04F 10/10; H02S 10/20; H02S 10/40; H02S 40/32

(52) U.S. Cl. CPC H02S 30/20; E04F 10/10; H02S 10/20; H02S 10/40; H02S 40/32

(57) ABSTRACT

A system has an electricity generating appliance having a frame providing a carport, the appliance having corner posts, cross-members, solar panels, and wiring interconnecting the solar panels, an inverter connected to the solar panels, one or more batteries connected to the inverter, a local breaker panel connected to an output of the inverter through a breaker, to a local electric grid through a main breaker and a two-way meter, and to loads of a local premise through breakers, and an Internet connected server hosted by a service configured to enter into agreements regarding power generation. The server manages the inverter and storage battery combination according to an existing agreement. The system further includes a Microgrid Interconnect Device (MID) configured to monitor grid conditions, manage transitions between grid-connected and islanded operation, and communicate with both inverter and server for coordinated energy dispatch, safety isolation, and automated reconnection to the utility grid.

### CROSS-REFERENCE TO RELATED APPLICATIONS

The instant application is a continuation-in-part (CIP) of co-pending application Ser. No. 19/350,425, filed on 6 Oct. 2025, which is a CIP of application Ser. No. 18/750,705, filed on 21 Jun. 2024, which is a CIP of application Ser. No. 18/348,989, filed on 7 Jul. 2023, now issued as U.S. Pat. No. 12,231,083, on 18 Feb. 2025, which is a CIP of application Ser. No. 17/981,065 filed 4 Nov. 2022, now issued as U.S. Pat. No. 12,040,737, on 16 Jul. 2024, which is a CIP of application Ser. No. 17/326,687 filed 21 May 2021 now issued as U.S. Pat. No. 11,515,833, on 29 Nov. 2022. All disclosure of the parent applications is incorporated at least by reference.

### BACKGROUND OF THE INVENTION

### 1. Field of the Invention

The present invention is in the technical area of solar power generation and pertains more particularly to a system configured as a vehicular, trailerable canopy.

### 2. Description of Related Art

Solar systems are notoriously well known in the art and comprise generally a plurality of solar panels that convert sunlight to electrical energy, the solar panels mounted to a fixed structure and connected an electrical apparatus termed an inverter that converts the DC voltage produced by the solar panels to a common voltage useful in a public or private electrical AC grid. In the United States a common voltage for conversion may be 240 volts AC, which is the finally stepped down voltage provided to most homes and businesses from the public grid.

A quite common circumstance involves solar panels mounted on fixed carrier apparatus on the roof of a home or business. This is a common pattern when dealing with a single home or business. In other circumstances solar panels may be mounted and connected in what might be termed a solar farm, where a large area of solar panels may be located on the ground in a rural area, for example, and the electrical output may be provided directly into a public grid, or to a private grid supplying a number of homes or businesses.

It is most common in the art that mounted solar panels are more or less permanently mounted, and not readily moved, such as known for solar panels in a roof installation. Therefore, such panels and the apparatus to which they mount are subject to radical weather events. Exposed panels may be severely damaged, for example, by hurricanes, hailstorms, wind driven debris, tornadoes, falling trees and branches in windstorms, and by a variety of other damaging circumstances.

Further to the above it is well-known that persons possessing such as a carport structure or an electricity-generating carport structure may on occasion have to relocate, or may wish to transfer ownership of the structure. In such a circumstance it will be advantageous if the structure may be converted to a towable trailer.

Further to the above it is known in the art to integrate local power generation with intelligence in a utility grid, such that power generation by the local generation system may be selectively fed into the grid at need.

The inventors believe that what is clearly needed is a system including a canopy appliance that is configured to power a local premise and to also feed the grid on demand from the grid.

### BRIEF SUMMARY OF THE INVENTION

In an embodiment of the invention a system is provided, comprising a free-standing electricity generating appliance having a frame in a rectangular aspect with a length a width and a height providing a canopy, the appliance having four corner posts, two forward and two rear, upper cross-members joining the corner posts, solar panels joined to individual ones of the upper cross-members, and circuitry and wiring interconnecting the solar panels, an inverter connected to the interconnected solar panels, one or more storage batteries connected to the inverter through remotely-operable switches, a local breaker panel connected to an output of the inverter through a breaker, to a local electric grid through a main breaker, an optional Microgrid Interconnect Device (MID) and a two-way meter, and to loads of a local premise through breakers, and an Internet connected server executing software and coupled to a data repository, hosted by a service configured to enter into agreements regarding power generation by the free-standing electricity generating appliance, the Internet-connected server coupled through the Internet network to the inverter. The Internet-connected server manages the inverter and storage battery combination according to an existing agreement, controlling the inverter and batteries to flow electricity through the two-way meter into the local grid.

In one embodiment of the system Internet-connected server tracks current flow into the utility grid and stops the current flow through the meter into the utility grid according to the existing agreement. Also, in one embodiment the system further comprises the corner posts having a square cross section and each corner post fastened to and supported on a base plate with an area greater than the cross section of the corner post. In one embodiment the upper cross members of the frame form a rectangular top supporting three horizontal solar panels, two solar panels are hinged to cross members of each long side of the top, and one solar panel is hinged to cross members of each short side of the top, for a total of nine interconnected solar panels. And, in one embodiment the frame further comprises apparatus configured to support the six hinged solar panels in a horizontal aspect.

In one embodiment the frame further comprises four removable wheel assemblies, one wheel assembly joined to a lowermost portion of each corner post, enabling the appliance to be rolled on the wheels. Also, in one embodiment the solar panels are bifacial solar panels. Also, in one embodiment the inverter is bidirectional and is configured to manage charge and discharge of the one or more storage batteries. In one embodiment the one or more storage batteries are removable, and are coupled through standardized connectors enabling portable and swappable energy storage. In one embodiment the Internet connected server is hosted by a service according to Virtual Power Plant (VPP) protocol, and the inverter is configured to receive and act upon remote dispatch instructions for (VPP) participation.

In another aspect of the invention a method for powering a premise electrically is provided, comprising providing a free-standing electricity generating appliance having a frame in a rectangular aspect with a length a width and a height providing a carport, the appliance having four corner posts, two forward and two rear, upper cross-members joining the corner posts, solar panels joined to individual ones of the upper cross-members, and circuitry and wiring interconnecting the solar panels, connecting the interconnected inverter of the free-standing electricity generating appliance to a Microgrid Interconnect Device (MID), connecting one or more storage batteries by connectors to the inverter through remotely-operable switches, connecting output of the inverter to a local breaker panel through a breaker, to a local electric grid through a main breaker with a MID and a two-way meter, and to loads of a local premise through breakers, and establishing communication between the inverter and an Internet connected server executing software and coupled to a data repository, hosted by a service configured to enter into agreements regarding power generation by the free-standing electricity generating appliance, the Internet-connected server coupled through the Internet network to the inverter, such that the Internet-connected server is enabled to manage the inverter and storage battery combination according to an existing agreement, controlling the remotely operable switches and the output voltage of the inverter to flow current through the two-way meter into the local grid.

In one embodiment the method comprises the Internet-connected server tracking current flow into the grid and stopping the current flow through the meter into the grid according to the existing agreement. In one embodiment the method further comprises providing the free-standing electricity generating appliance with the corner posts having a square cross section and each corner post fastened to and supported on a base plate with an area greater than the cross section of the corner post. In one embodiment the method comprises providing the free-standing electricity generating appliance with the upper cross members of the frame forming a rectangular top supporting three horizontal solar panels, two solar panels hinged to cross members of each long side of the top, and one solar panel hinged to cross members of each short side of the top, for a total of nine interconnected solar panels. And in one embodiment the method comprises providing an apparatus configured to support the six hinged solar panels in a horizontal aspect.

In one embodiment the method comprises providing the frame with four removable wheel assemblies, one wheel assembly joined to a lowermost portion of each corner post, enabling the appliance to be rolled on the wheels. Also, in one embodiment the method comprises providing the solar panels as bifacial solar panels. Also, in one embodiment the method comprises providing the inverter as a bidirectional inverter configured to manage charge and discharge of the one or more storage batteries. In one embodiment the method comprises providing the one or more storage batteries as removable, and coupling the batteries through standardized connectors enabling portable and swappable energy storage. And in one embodiment the method comprises hosting the Internet connected server by a service according to Virtual Power Plant (VPP) protocol, and configuring the inverter to receive and act upon remote dispatch instructions for (VPP) participation.

### BRIEF DESCRIPTION OF THE SEVERAL VIEWS OF THE DRAWINGS

FIG. 1 is a perspective view of a movable framework in an embodiment of the present invention.

FIG. 2 is a perspective view of the framework of Fog. 1 showing where solar panels are mounted in an embodiment of the invention.

FIG. 3 is a plan view of an upper level of the framework showing six solar panels mounted in an embodiment of the invention.

FIG. 4 is an end view of the framework showing how additional solar panels may be added to the framework.

FIG. 5 is a perspective view of a frame mounted to the side tubes to better illustrate the nature of the mounting in this embodiment.

FIG. 6 illustrates the movable framework with mounted solar panels positioned in a driveway leading to a garage door.

FIG. 7 is a perspective view of the framework in the driveway with outside panels lowered.

FIG. 8 is a perspective view of the driveway with the framework rolled into the garage.

FIG. 9 is a perspective view of a driveway with tracks to guide the framework as the framework is moved.

FIG. 10 is an end view of the framework in an embodiment employing a drive motor and wheel.

FIG. 11A is a perspective view of a solar canopy structure in another embodiment of the invention.

FIG. 11B is a perspective view of the structure of FIG. 11A with tubes removed to produce two separate portable units.

FIG. 12 is a perspective view of a MEGA canopy in one embodiment of the invention.

FIG. 13 illustrates a rectangular flat base of the canopy of FIG. 12 in an embodiment of the invention.

FIG. 14 is a perspective view of the canopy of FIG. 12 with solar panels raised in an embodiment of the invention.

FIG. 15 is a side elevation view of a framework of the canopy of FIG. 12 in an embodiment of the invention.

FIG. 16 is an end elevation view of a framework of the canopy of FIG. 12 in an embodiment of the invention.

FIG. 17 illustrates a high-load wheel assembly mounted to a post in an embodiment of the invention.

FIG. 18 illustrates the wheel assembly of FIG. 17 from a different viewpoint in an embodiment of the invention.

FIG. 19 illustrates an anchor system in an embodiment of the invention.

FIG. 20 is a side elevation view of a VEGA Canopy in an embodiment having a trailer dolly and rear wheels.

FIG. 21 is a rear elevation view of the VEGA canopy appliance of FIG. 20.

FIG. 22 is a center section view of the VEGA canopy appliance of FIG. 20.

FIG. 23 is a side elevation view of a VEGA Canopy in an alternative embodiment.

FIG. 24 is a center section view of the VEGA canopy appliance of FIG. 23.

FIG. 25 is a side elevation view of the VEGA canopy appliance of FIG. 23 showing a travel cover.

FIG. 26 is a perspective view of a free-standing canopy structure that may be used as a carport, and may also generate electricity.

FIG. 27A is a perspective view of a wheel assembly on a post at a rear of a trailer formed from the structure.

FIG. 27B is an exploded view of elements in FIG. 27A.

FIG. 28 is a perspective view of a front of the trailer of FIG. 27A.

FIG. 29 is a diagram of a system in an embodiment of the present invention.

### DETAILED DESCRIPTION OF THE INVENTION

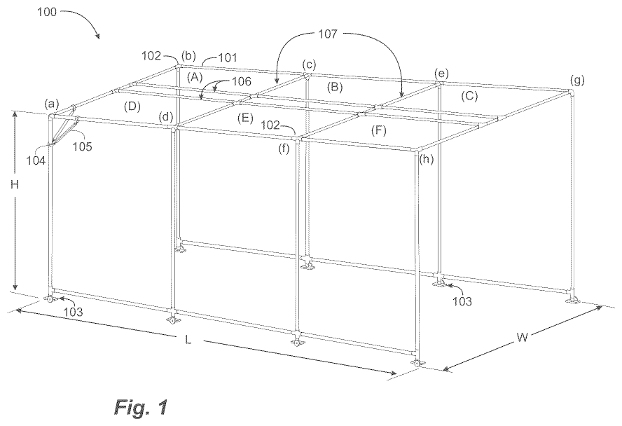

FIG. 1 is a perspective view of a movable framework 100 in an embodiment of the present invention. Framework 100 in this example is constructed of aluminum tubes sections such as section 101 which are joined by cast aluminum fittings such as fitting 102, which is a corner fitting. Many such fittings are commercially available. In the present example the tubes are standard 2.0 inch OD aluminum tubes, and once joined with a fitting, tubes sections are TIG welded to the fittings.

Each upright (vertical) element in framework 100 ends at the lowermost extremity with a wheel assembly such as assembly 103. In this example there are eight such wheel assemblies. In some embodiments there may be more or fewer than eight, and the wheel assemblies may have a locking brake. In alternative embodiments the wheels may be extendable and retractable, such that the framework may be caused to rest directly on a supporting surface with the wheels raised.

One corner (a) of the framework is shown to be reinforced by braces 105 between clamps 104 fastened to the aluminum tubes. Although not explicitly shown in the figure, corners (b) through (g) may be similarly braced, and typically will be so braced. This triangulation adds needed strength and rigidity to the framework.

In FIG. 1 it is seen that the framework has a horizontal upper level defined by corners (a), (b), (h) and (g). This upper level is divided in this example by two lengthwise tube arrangements 106 and by two lateral tube arrangements 107, into six rectangular regions labeled in this example (A), (B), (C), (D), (E) and (F). These regions are sized by the placement of these tube arrangements to be of the size of solar panels to be used with the system, as is described in enabling detail below.

Framework 100 has a height H, a width W, and a length L in this example, and these dimensions are important to the purpose of the invention. In one embodiment the framework supports solar panels in a solar panel system that doubles as a canopy and utilizes driveway space to expose solar panels to sunlight to generate electrical energy, which may be used both for supplementing electrical power in a household or commercial building associated with the driveway or parking space, and to charge batteries for electrical vehicles that may be under the framework or in a nearby garage.

Width W for purposes of the invention needs to be wider than an automobile associated with the system in a use case, but more narrow than a width of a garage doorway associated with the system, length L needs to as long as or longer than the automobile, and height H needs to be higher than the overall height of the automobile but less than the height of the garage door. It will be apparent that these dimensions may vary depending on use case and application, but one set of dimensions may well work for most applications.

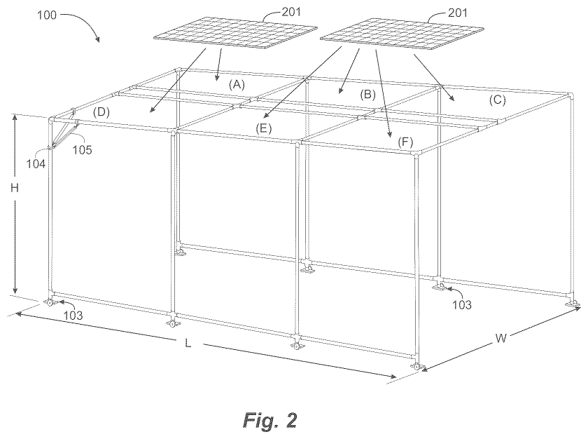

FIG. 2 is a perspective view of framework 100 of FIG. 1 with solar panels 201 shown to be added to regions (A) through(F). In this example the solar panels are GCL-M6/72DH Bifacial panels. Bifacial means that the 12 solar cells that make up one solar panel 201 are made to be active on both sides. When installed in regions (A) through (F) of the framework these six panels will be active especially for sunlight from above but will also be active and will generate electricity by reflected sunlight from surfaces of a vehicle under the framework.

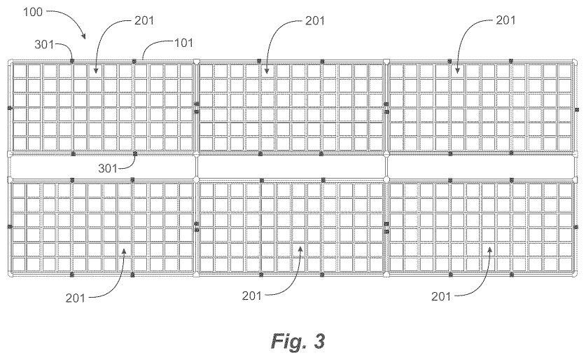

FIG. 3 is a plan view of the upper level of framework 100 with solar panels 201 installed in each of the six regions (A) through (F) in this example. In this example the solar panels are GCL-M6/72DH Bifacial panels as indicated above, with each panel about 80 inches in length, so the overall length of the structure is a little more than three times this dimension, or about 20 feet in length. The width is about 8 feet. The solar panels are retained within each of regions (A) through (F) by use, in this example, of connectors 301, which in this example are clamps that are attached over the 2 inch tubes of the tubular frame, and connect to holes on the sides of the solar panels. This, it will be understood, is just one of a variety of ways that the solar panels may be secured in the regions of the framework. In the example of FIG. 3 there are 6 solar panels exposed to sunlight, but the structure in embodiments of the invention is not limited to 6 panels.

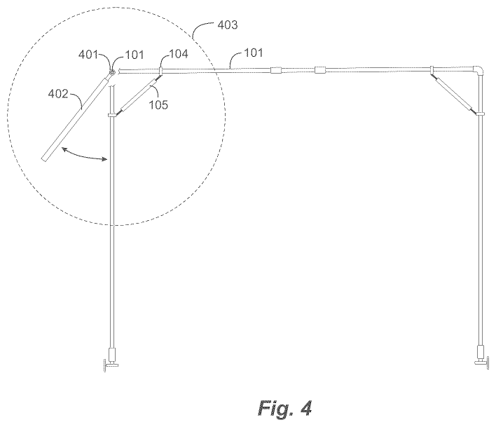

FIG. 4 is an end view of framework 101 showing mounting of additional panels to outside tubes of the framework in a manner that the additional panels may be rotated into a horizontal position for maximum effect and may be rotated to a nearly vertical position to enable the framework to minimize the overall width to enable the structure to be moved, for example, from a driveway to inside a garage. In FIG. 4 a corner cast aluminum fitting is removed in the figure to show a clamp mechanism 401 mounted to a lengthwise upper tube, with the clamp mechanism attached to a panel frame 402 which may hold a solar panel. The frame 402 is shown at an angle of about 30 degrees from vertical but may be lowered to minimize the overall width of the structure or raised so that a mounted solar panel in frame 402 may be horizontal for maximum sunlight exposure.

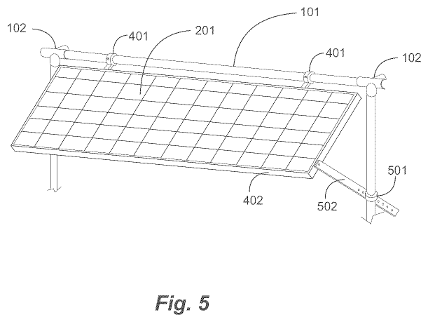

FIG. 5 is a perspective view of frame 402 mounted to the side tube 101 to better illustrate the nature of the mounting in this embodiment. Frame 402 mounts a solar panel 201 the same as the solar panels mounted in the upper level as shown in FIG. 3. Clamp mechanisms 401 may be loosened to rotate frame 402 and tightened to secure the frame, and therefore the solar panel, at a new attitude, including a horizontal attitude parallel with the solar panels mounted in the upper level. In an alternative embodiment there may be props 502 connecting to anchors 501 by which the side panels may be raised or lowered. It will be apparent that there are a variety of ways that side frames 402 carrying solar panels may be raised or lowered.

As many as six frames 402 with solar panels 201 may be provided along the sides of the framework, three along each side, which effectively doubles the number of solar panels in the apparatus, to twelve.

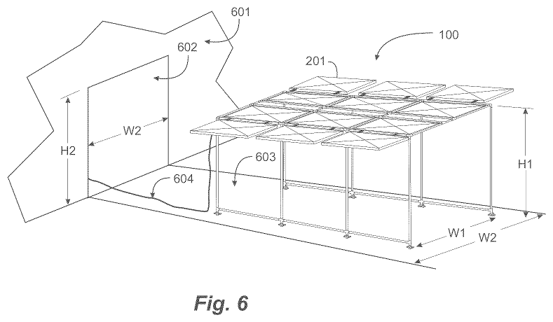

FIG. 6 illustrates movable framework 100 with a full complement of mounted solar panels 201 positioned in a driveway or parking space 603 leading to a garage door 602 in a side of a home or business 601. It may be seen that the extra side panels to each side of the framework are deployed level with the solar panels in the top of the framework such that all twelve solar panels are parallel and horizontal. Width of the driveway is W2 which is greater than the width W1 of framework 100. The width of the garage door opening is also W2, the same as the width of the driveway in this example. The height of the framework H1 is less than the height w2 of the garage door. The deployment of the side panels provides maximum energy generation, which is routed to an inverter in the garage by a cable 604, but this makes the overall width greater than the width W2 of the garage door. In this configuration the moveable framework cannot be rolled into the garage.

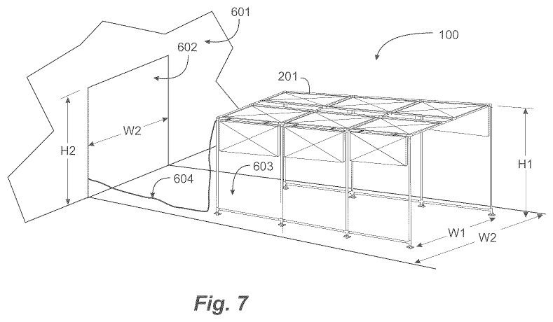

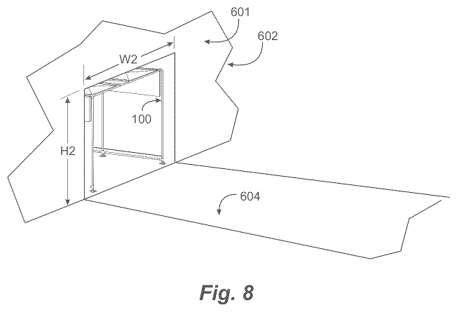

FIG. 7 illustrates the circumstance of FIG. 6 except the side panels have been retracted to a vertical position, reducing the overall width of the framework with panels to W1. In this configuration the framework with panels may be rolled into the garage through the garage door. FIG. 8 illustrates the framework 100 with solar panels moved into the garage through the garage door.

In the examples shown and described, with a framework with solar panels stored in the garage, an automobile, a truck or motorcycles may still be parked in the garage beneath the framework, as the inside height and width of the framework is high and wide enough to clear most automobiles. A user may open the garage door and manually roll the framework on wheel assemblies 103 out of the garage through the garage door, trailing cable 604 until the framework is fully deployed in the driveway. The side panels may then be deployed level, and the system will generate electricity. At a time when a weather event, or for some other reason it is determined to store the framework in the garage the side panels may be lowered, the garage door opened, and the framework may be rolled back into the garage with enough space to also park the car underneath.

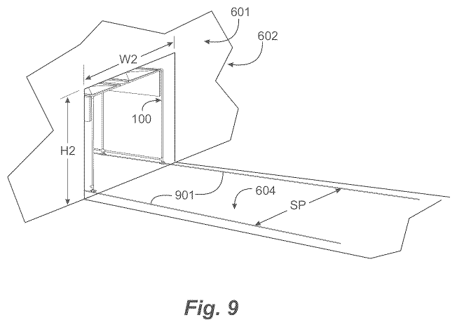

Cable 604 in one embodiment ends in a standard 240 volt connector, which may be plugged into an inverter to connect into the house or business wiring, and the solar panel system will supplement electrical usage in the home or business as an electricity generating appliance. In one embodiment the inverter is a Solar Edge™ HD Wave inverter which accepts a 240V connector and also provides connectors for charging electric vehicles. The inverter in one embodiment is mounted just inside the garage door but may be positioned elsewhere as well. The entire system functions as an electricity generating, portable appliance in one unit. FIG. 9 illustrates an embodiment of the system wherein optional tracks 901 are provided on the driveway at a spacing SP to match the distance between wheels 103 on the movable framework. The optional tracks may be either cut into the driveway or strips of material may be laid onto and adhered to the surface of the driveway to form the tracks. The optional tracks guide the framework both going into and coming from the garage.

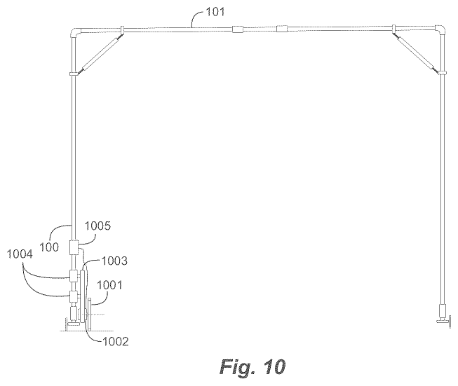

FIG. 10 illustrates an alternative embodiment wherein a single wheel 1001 driven by a DC motor 1002 mounted in a frame 1003 fastened to an upright of the framework by clamps 1004 is provided on one side at a lower level of the framework at the end of the framework that first enters and last leaves the garage. The motor may be driven in either direction and turned on and off to propel the framework from the garage and to bring it back into the garage. On-off and direction inputs may be provided on a small junction box 1005 fastened to an upright of the framework near the motor and wheel. In an alternative embodiment there may be circuitry in junction box 1003 with Bluetooth or other wireless communication capability, and an application may be provided on a smart phone with an interactive interface to operate the drive wheel to propel the framework into or out of the garage. This apparatus works best in an embodiment wherein tracks, as in FIG. 9, are provided to constrain the wheels 103 of the framework.

In one embodiment cable 604 that connects the solar panels of the apparatus of the invention to an inverter may be wound on a reel in the garage with spring constraint, such that the cable plays out as the framework is moved from the garage to a position in the driveway, and winds back on the reel as the framework re-enters the garage.

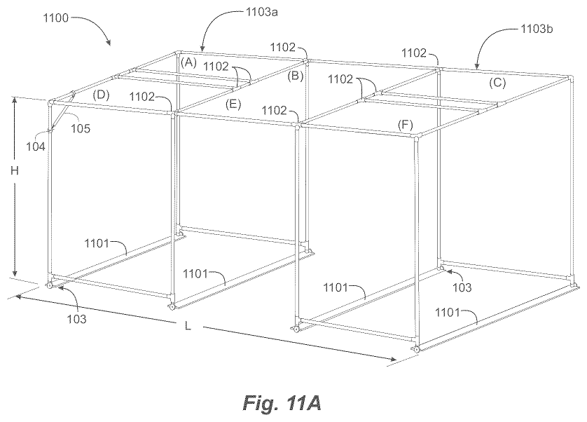

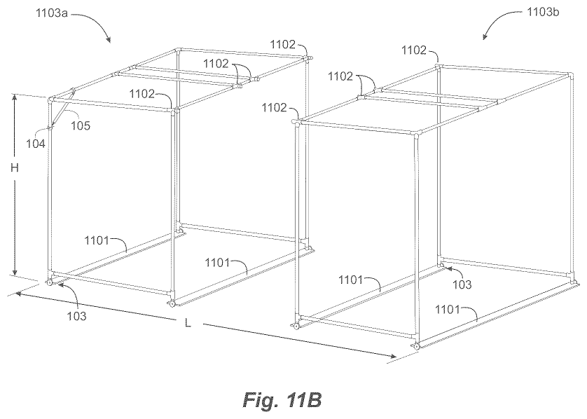

FIG. 11A is a perspective view of a structure for a portable solar canopy in another embodiment of the invention. In this embodiment two rectangular structures 1103a and 1103b that are mirror images are joined by tubes only at the upper level, the tubes engaged in fittings 1102 that are fittings that enable the tubes to be engaged and disengaged. The structures are joined side-to-side additionally by flat bars 1101.

In this embodiment wheel assemblies 103 are of a commercially available sort well-known in the art that may be deployed and retracted such that the structure may be slightly raised on caster wheels that allow universal horizontal movement and lowered to cause the structures to rest on the flat bars 1101.

With the structures 1103a and 1103b joined as shown in FIG. 11A solar panels may be mounted exactly as described above with reference to FIG. 2 and also referenced in other descriptions, and the joined structure may reside on a driveway providing electricity generation just as described herein in other embodiments.

When a user has determined to store the portable solar canopy in a garage or other storage area the user may disconnect the tubes joining structures 1103a and 1103b by releasing the tubes joined by fittings 1102 and removing the tubes. FIG. 11B illustrates the result, with structures 1103a and 1103b now separate structures, separately movable. The user may now deploy the caster wheel mentioned above to raise the structures separately on the caster wheels, and each structure may be separately rotated and moved into the garage separately. This innovation provides a means of moving and deploying the overall structure of the portable solar canopy that is easier for the user to manually manipulate.

In one embodiment of the invention individual ones of the solar panels may be connected directly to a micro-inverter, converting the direct current (DC) produced to an alternating current (AC).

Having illustrated and described a number of examples of the invention it is again emphasized here that the framework is open both in the front and the rear with sufficient height and width that a user may park an automobile or other vehicle under the framework with the framework positioned in the driveway to present solar panels to sunlight. Moreover, the user may drive a vehicle under and through the framework and into the garage. The system of the invention presents no real impediment to the use of the garage or the driveway.

### MEGA Version

In alternative embodiments of the invention a more robust and serviceable version of the solar canopy appliance is provided with additional functionality over the embodiments described above. MEGA stands for Mobile Electricity Generating Appliance.

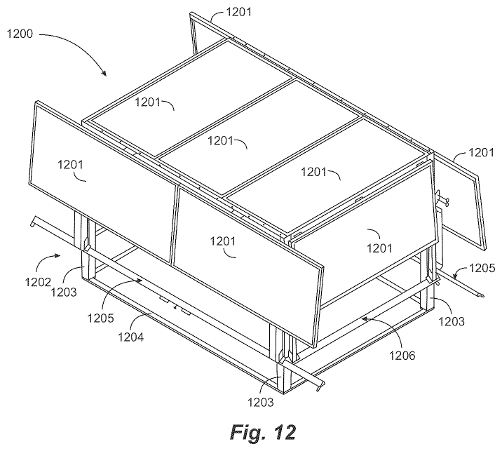

FIG. 12 is a perspective view of a VEGA canopy 1200 in one embodiment of the invention. Canopy 1200 comprises nine (9) bifacial solar panels 1201 one of which is not seen in FIG. 12, being implemented on a far end of the canopy not visible in the view of FIG. 12. In FIG. 12 panels 1201 are carried on a sturdy framework 1202 having four corner posts 1203 (three corner posts are visible in FIG. 12) that are made from 4″×4″ aluminum square tube stock. In one embodiment the wall thickness of the square tube stock is ⅛ inch, but in some instances, for a more sturdy version, tubes with a wall thickness of 3/16 inch or even ¼ inch may be used. Two solar panels 1201 on each long side and one solar panel on each width end are hinged at an upper edge and folded down in a position suitable for moving the portable solar panel. Lengthwise and widthwise cross braces are implemented in framework 1202 but not seen under the folded down solar panels on the sides and ends of the canopy.

A rectangular flat base 1204 with four sides each in one embodiment one-half the width of a post 1203 (2″) lies flat on a support surface, such as a driveway, which support surface may be concrete or asphalt, and posts 1203 of framework 1202 are joined to this base at the four corners, such as by steel bolts.

Two lengthwise support structures 1205 are hinged to corner posts 1203 on each long side in a manner that the support structures may be deployed to support the two solar panels on each side of the canopy when those panels are raised on their hinged edges to a horizontal plane with the solar panels on the top of the canopy. Similarly, there are two support structures 1206, one on each end of the canopy, hinged to the corner posts of the framework on each end, which may be deployed to support the single solar panels on each end of the canopy when those panels are raised on their hinged edges to a horizontal plane with the solar panels on the top of the canopy. When the four side and two end solar panels are raised and supported horizontally there are nine (9) solar panels in a horizontal plane displayed to catch maximum rays.

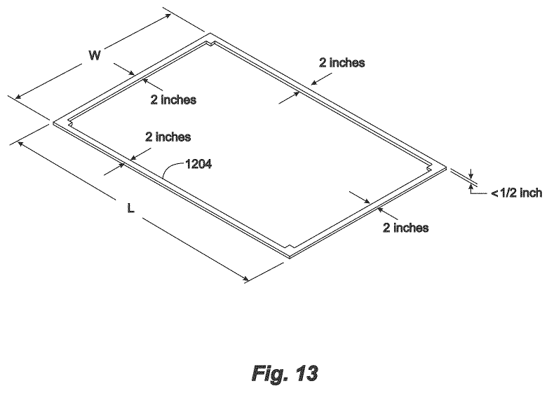

FIG. 13 illustrates rectangular flat base 1204 in the same aspect as in FIG. 12. Base 1204 lies flat on the supporting surface, which may be a driveway surface, such that, with the framework 1202 engaged and the solar panels raised, a car, truck or other vehicle may be driven over the base under the canopy through either the ends or the sides of the canopy. Base 1204 has a length L and a width W which are also the width and length of the framework in a canopy on the base. In one embodiment W is about 8 feet and length L is about 20 feet, but both of these dimensions may be different in other embodiments. A 4″ by 4″ region is implemented on each corner of base 1204 to mate with the 4″×4″ bottom of the corner posts 1203. In an alternative embodiment the width of each span of the base may be 4″ rather than two inches.

Base 1204, having a limited height, such as equal to or less than one-half inch, provides considerable structural support for the framework and presents very little impediment to a vehicle driven over a span of the base. The length and width of base 1204 may vary in different embodiments, but with framework posts 1203 at 4 inches square, the width of each span of base 1204 will be 4 inches.

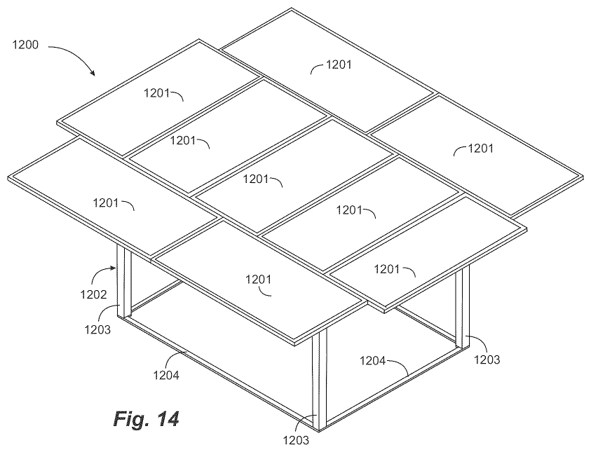

FIG. 14 illustrates the canopy 1200 with the six hinged solar panels raised to the horizontal plane of the three solar panels that are arrayed on the top of the framework and are not hinged. The apparatus 1205 and 1206 that are hinged on the corner posts are not seen in FIG. 14 under the solar panels. FIG. 14 shows the canopy in an arrangement for operation, with all of the solar panels in horizontal aspect and coplanar.

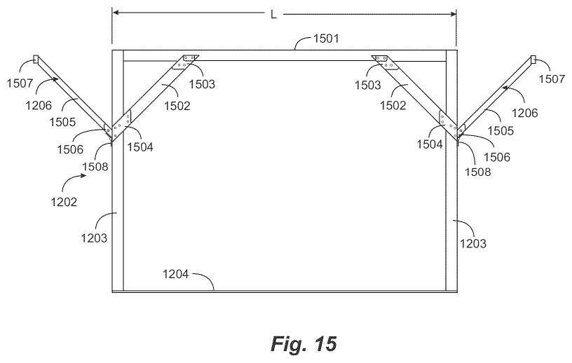

FIG. 15 is a side elevation view of framework 1202 with apparatus 1206 on hinges 1508 on each end raised in position to support the single hinged solar panels on each end of the canopy in a horizontal aspect. Apparatus 1206 in FIG. 12 is shown as folded down against posts 1203, which allows the solar panels on the ends to fold down to a vertical aspect. Each apparatus 1206 comprises an arm 1505 made from square aluminum tubes, hinged in a bracket 1506 that is fastened to post 1203. A rail 1507 fastened in a horizontal aspect at ends of arms 1505 supports the end solar panels in the raised aspect.

A 4-inch L-shaped beam 1501 in this example spans between posts 1203. Beam 1501 is supported on each end to posts 1203 by a 4-inch square brace 1502 fastened between brackets 1503 and 1504, which brackets in this example fasten respectively to the beam and to the posts.

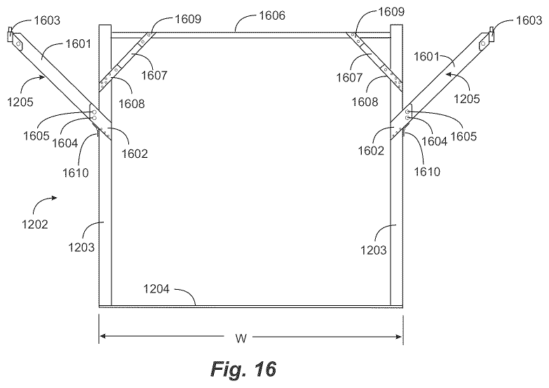

FIG. 16 is an end elevation view of framework 1202 with hinged apparatus 1205 on each side raised in position to support the two hinged solar panels on each side of the canopy in a horizontal aspect. Apparatus 1205 in FIG. 12 is shown as folded down against posts 1203, which allows the solar panels on the sides to fold down to a vertical aspect. Each apparatus 1205 comprises an arm 1601 made from 4″ square aluminum tubes in this example, hinged in a bracket 1602 that is fastened to post 1203. A rail 1603 fastened in a horizontal aspect at ends of arms 1601 supports the side solar panels in the raised position. Arm 1601 pivots on a hinge 1610, pins 1604 & 1605 are inserted in the raised position to support arm 1601.

Canopy 1200 as described in the VEGA version is intended to be deployed on premises, such as on a driveway in front of a garage, on a semi-permanent basis. Earlier versions described above had deployable and retractable wheels such as wheel assemblies 103 described above. It has been determined that it may be better to have removable wheel assemblies, since the canopy may need to be moved only occasionally, and the wheel assemblies may be best not exposed to the elements except when needed. Further, it has been determined there needs to be a means of anchoring the canopy to the surface upon which it rests, as some driveways are not level, and wind may occasionally be a problem. In some regions tornadoes or hurricanes may be a problem.

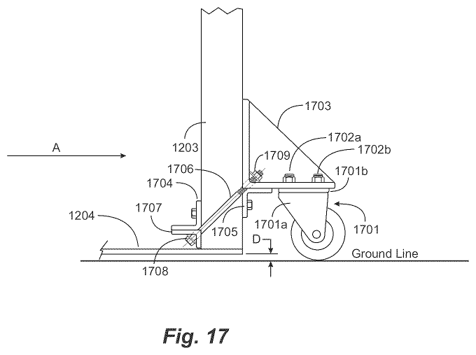

FIG. 17 is an elevation view of one corner post 1203 of the MEGA version canopy illustrating a removable, high-load wheel assembly 1701 having a wheel made in this example from a Ultra High Molecular weight (UHMW) polymer. Wheel assembly 1701 has an upper portion 1701b that bolts under a bracket 1703 by four nuts and bolts of which 1702a and 1702b may be seen in the figure, and a lower part 1701a that is free to rotate relative to part 1701b around a vertical axis. Bracket 1703 is about two inches wider than post 1203 in this example, about six inches, and extends one inch from each side of post 1203. Bracket 1703 is not bolted to post 1203, but rests on an L-bracket 1705 that is the width of the post, four inches, and is bolted to post 1203. A second L-bracket 1704 also of four-inch width is bolted to post 1203 on an opposite side from L-bracket 1705 at a predetermined lower position. A third L-bracket 1707 has a width of six inches, like bracket 1703, and two holes at an angle, passing through the bracket at the corner as shown, in the extended portions outside the post. Bracket 1703 has similar holes in the extended portions outside the post. Some embodiments use angles between 10 and 80 degrees and preferably between 25 and 65 degrees. Two long steel bolts 1706 in this example pass through the angled holes in brackets 1703 and 1707 and are constrained at the top end by a nut and washer 1708 and 1709. Only one bolt and one nut and washer is seen in this view.

A person of skill in the art will understand that with nut 1709 loosened such that bracket 1703 is not urged against bracket 1705, the framework of the canopy will rest on the supporting surface at the ground line. As the nuts are tightened, bracket 1703 is drawn against bracket 1705, and the framework is lifted from the ground line to a height “D” which is determined by the relative positions of brackets 1704 and 1705.

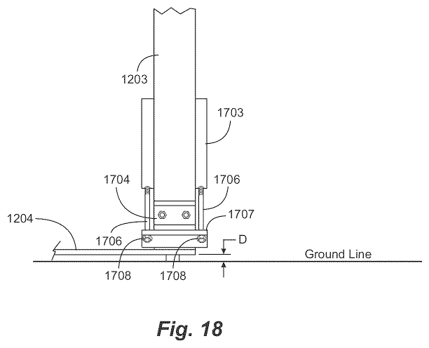

FIG. 18 is a view of the assembly of FIG. 17 in the direction of arrow A in FIG. 17, to better illustrate the nature of the assembly. Bracket 1704 is seen bolted to post 1203 on the near side of the post, and bracket 1707 is seen with bolt 1706 passing through at an angle. Bracket 1703 may be seen on the far side of post 1203 with threaded rods 1706 passing through bracket 1703 at an angle. The threaded rods are secured to bracket 1703 by nut and washer sets 1709, not seen in FIG. 18 but shown in FIG. 17.

The apparatus illustrated in FIGS. 17 and 18 may be implemented at all four corners of the canopy 1200, and once installed and secured the entire canopy is raised on wheels and may be moved along the supporting surface either to store in a garage or other storage facility. The canopy may be moved as well on the wheels to a different location or onto a conveyance vehicle to be carried away.

The inventor believes the apparatus shown in FIGS. 17 and 18 is capable of supporting the considerable weight of the MEGA version of the canopy and facilitating the mobility of the canopy. When the canopy is moved or repositioned, and is in a position desired by the user, the wheel assemblies may be removed, placing the canopy back on the supporting surface.

Once replaced on the supporting surface there may be occasion of expected high winds, even a tornado or a hurricane, that could move or damage the canopy. To protect against such an occurrence, if it is neither desirable nor possible to move the framework inside a shelter, an anchoring system is provided to secure the canopy by its framework to the supporting surface.

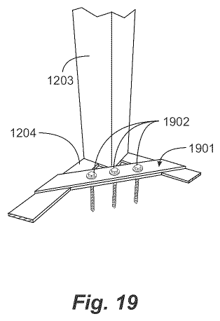

FIG. 19 illustrates one corner post 1203 of the MEGA version of the canopy in one embodiment. A cross brace 1901 is placed at an angle between spans of base 1204. Some embodiments use angles between 10 and 80 degrees and preferably between 25 and 65 degrees. There are three through holes in the cross brace and anchor bolts 1902 are used to anchor the canopy to the supporting surface. One such cross brace with anchor bolts is used preferably at each corner post to very securely anchor the canopy to the surface.

In some embodiments a base 1204 may not be used. In this circumstance a cross brace similar to element 1901 may be attached directly to a corner post, and in some embodiments without a base plate a foot of greater horizontal area than the post may be attached to the post. The cross brace may in this circumstance be attached to the foot at the base of the post.

In one embodiment, once the canopy is deployed on a driveway or other supporting surface, the anchoring cross braces are installed if not already in place. Locations for anchors in the supporting surface are marked through the three holes in each cross brace. The canopy is moved aside a short distance, and holes are drilled in the surface and anchors are installed to accept the anchor bolts. Once the anchors are installed the canopy may be positioned properly over the anchor points and the anchor bolts engaged to securely anchor the canopy to the supporting surface.

### VEGA Version

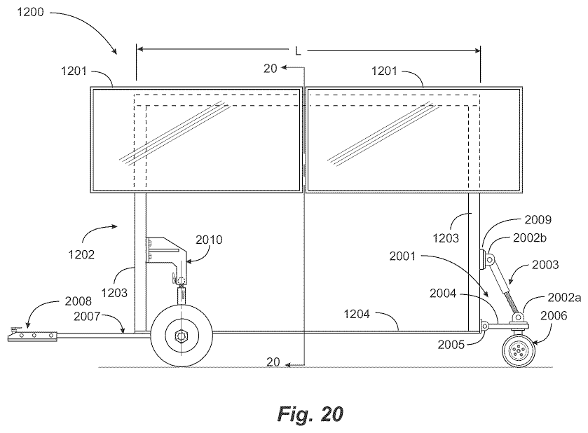

In another aspect of the invention a VEGA (vehicular) Canopy, more properly a Vehicular Electricity Generating Canopy Appliance, is provided that may be towed by an automobile or a truck for relocation. FIG. 20 is a side elevation view of such a VEGA Canopy 1200 showing a sturdy frame 1202 having corner posts 1203 as shown in FIG. 12, a rectangular flat base 1204, and solar panels 1201 folded downward for transit. A removeable, wheeled assembly 2001 on a rear portion of the canopy has a pivoted base 2004 with a first bearing pivot 2002a on the base and a second bearing pivot 2002b attached to corner post 1203. There is a combination spring/shock assembly 2003 attached between the two bearing pivots. A caster assembly 2006, which may be a commercially available assembly such as a Hamilton R-7210-PR assembly, which is a rigid unit, is attached below the base. There is no need in this version for a swivel caster assembly. Base 2004 is free to pivot vertically around a bearing pivot 2005, also attached to the corner post, against the spring and shock assembly. The assembly seen in this side view is one of at least two on the rear of the canopy, with a second assembly joined to the corner post beyond the corner post seen in FIG. 20.

In this example a trailer dolly 2007 is provided at a forward portion of the canopy to carry the forward portion in transit, and the trailer dolly has a commercial hitch 2008 compatible with standard hitch balls. A bracket assembly 2010 is fastened spanning the corner posts at the front of the canopy to mate with a vertically-extended ball of the trailer dolly 2007.

The skilled person will understand that the VEGA canopy appliance is made such that a car may pass under the structure with the solar panels in either direction, lengthwise or widthwise, with the solar panels deployed. Accordingly, it will be apparent that at least bracket assembly 2010 will need to be provided and assembled to the front corner posts of the canopy at the time that a user wishes to tow the canopy and removed to place the canopy again on a ground surface.

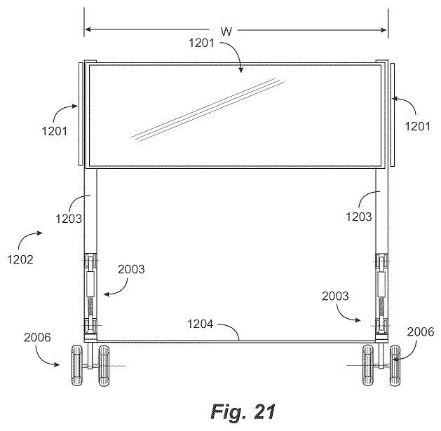

FIG. 21 is a rear elevation view of the canopy of FIG. 20 illustrating the two spring and shock units 2003 attached to the rear-facing surfaces of the rear two corner posts 1203. There are two combination spring/shock assemblies 2003 one on each side of the canopy. Each set of wheels with spring and shock absorber may operate independently. The two assemblies are relatively easy to add to a canopy and to remove if such is desired. Both may be retracted with the casters off the ground surface without occluding the width between the corner posts for a vehicle to pass.

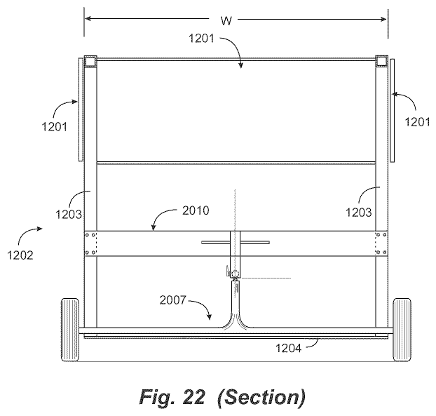

FIG. 22 is a section view from the same viewpoint as FIG. 21, with the section line through a midpoint of the length of the canopy, to be able to illustrate the placement of trailer dolly 2007 in the embodiment shown in FIG. 20. Bracket assembly 2010 is shown bolted across the inside edges of the corner posts in front. Trailer dolly 2007 presents a ball for a hitch on the bracket assembly 2010. The front weight of the canopy in transit is carried by the trailer dolly connected to bracket assembly 2010.

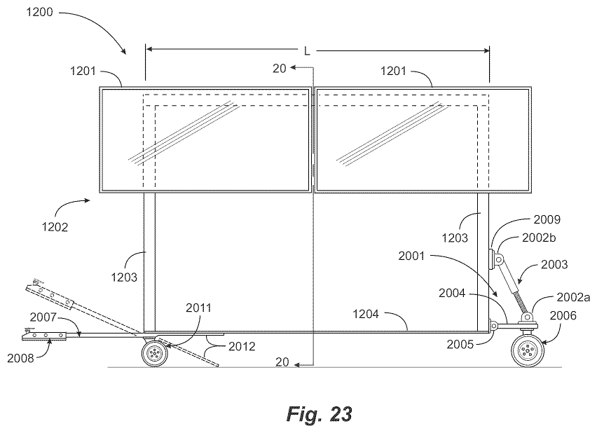

FIG. 23 is a side elevation view of a VEGA canopy in yet another embodiment. In this embodiment the casters with shocks and springs attached to the rear corner posts are the same as in the version illustrated in FIG. 20 and FIG. 21. In this version the dolly has a plate of the width of the canopy, underlying both forward corner posts, and there are two swivel casters 2011, one fastened to the plate directly under each corner post. The swivel casters are of the trailing sort, with an angled post, The plate has a forward central extension to the ball hitch 2008 and a rearward extending portion 2012 of the width of the canopy, which, with the ball hitch raised as shown in FIG. 23 provides a loading ramp 2012 which may be positioned against ground surface by lifting the forward region of the dolly. The position of the ramp when tilted is shown in FIG. 23 in dotted outline. Once the frame is loaded up the ramp, which may be done in several ways, and the dolly is repositioned with the ramp level there may be fasteners (not shown) to attach the frame to the ramp and the dolly.

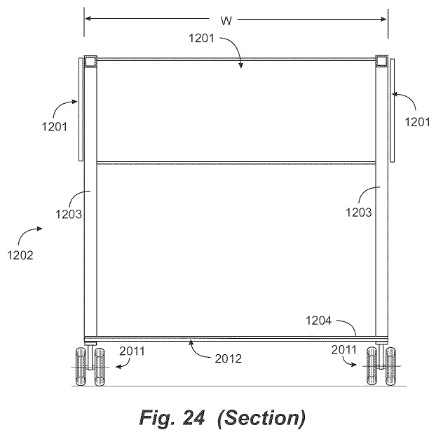

FIG. 24 is a section view from the same viewpoint as in FIG. 22 showing plate 2012 underneath flat base 1204 of the canopy and the two swivel casters 2011, one directly beneath each forward corner post.

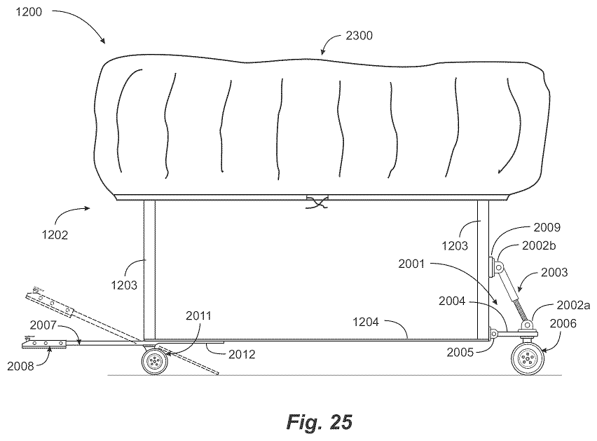

FIG. 25 is a side elevation view like FIG. 20 with a canvas cover 2300 installed over the canopy for protection in transit and tied down. Cover 2300 in one embodiment is a cover with an inner and an outer layer with a filling to provide a cushioning effect for elements of the canopy in transit.

### TEGA Version

In one embodiment of the instant invention a Trailerable Electricity Generating Canopy Appliance (TEGA) is provided in which a free-standing canopy appliance may be modified by a set of add-on elements that convert the free-standing canopy appliance into a public street-legal licensed trailer that may be towed legally on public streets and highways.

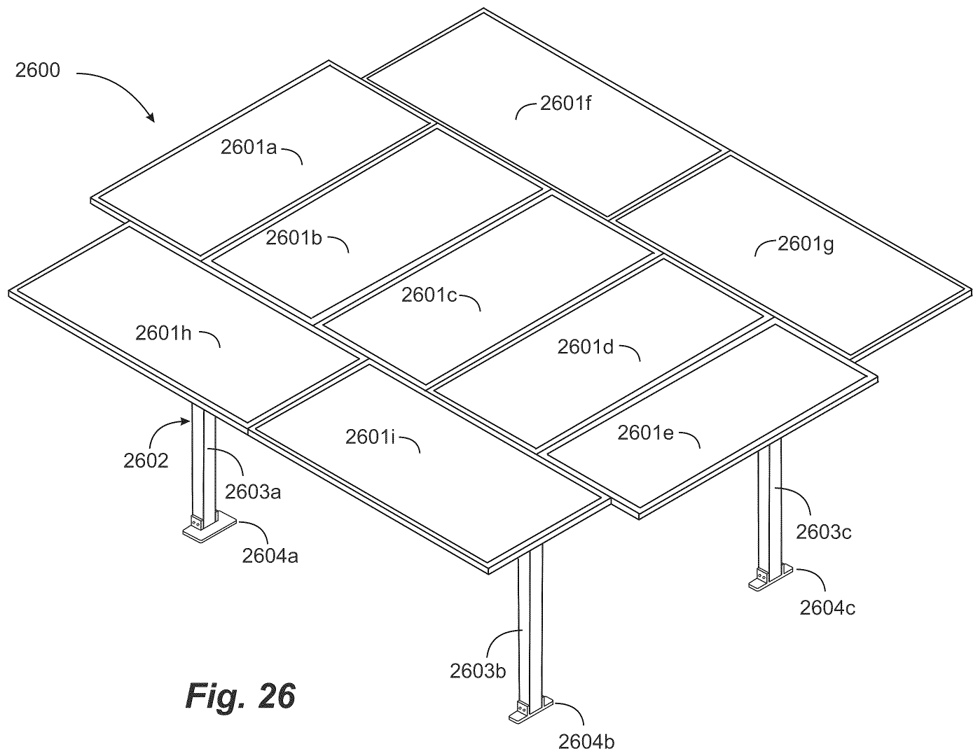

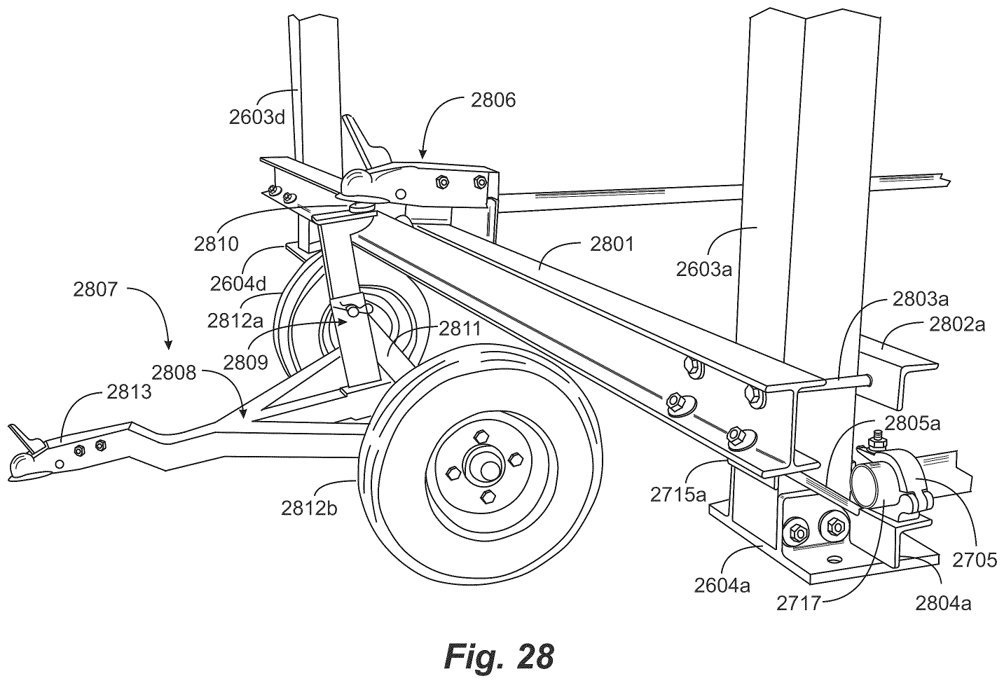

FIG. 26 is a perspective view of a free-standing canopy appliance 2600 in one embodiment of the invention that may be positioned in a user's driveway or other location, and may be used as a carport. Equipped with solar panels this appliance may be used to generate electricity as described in enabling detail above. In this example TEGA canopy appliance 2600 comprises nine (9) bifacial solar panels 2601a through 2601i, In FIG. 26 panels 2601a through 2601i are carried on a sturdy framework 2602 having four corner posts 2603a through 2603d (three corner posts are visible in FIG. 26) that are made in this example from 4″×4″ aluminum square tube stock. In one embodiment the wall thickness of the square tube stock is ⅛ inch, but in some instances, for a more sturdy version, tubes with a wall thickness of 3/16 inch or even ¼ inch may be used. In the example of FIG. 26 each post has a bolted-on saddle-shaped foot noted in the Fig. as feet 2604a, 2604b and 2604c (2604d is not seen). Detail of the feet is provided additionally below in FIG. 28. The added feet provide a sturdy base for the corner posts by increasing the area of surface contact. In FIG. 26 the solar panels are shown in a raised position such that all panels are substantially in a horizontal plane. In another circumstance outer panels 2601f, 2601g, 2601h and 2601i as well as end panels 2601a and 2601e may be folded down to a vertical planar aspect and may be secured in the down position in a circumstance where a TEGA canopy appliance may be moved or towed as a trailer.

To convert the canopy appliance 2600 of FIG. 26 into a street-legal trailer it is necessary to provide wheels joined to the frame 2602. In one embodiment removable wheels are assembled to posts 2603b and 2603c with springs and shock absorbers. In this embodiment the end of the frame with posts 2603b and 2603c is the rear of the trailer. A dolly is provided at a front of the trailer to carry the front of the trailer and to connect to as trailer hitch on a towing vehicle. Details of the dolly and hitch apparatus are provided in enabling detail below referencing FIG. 28.

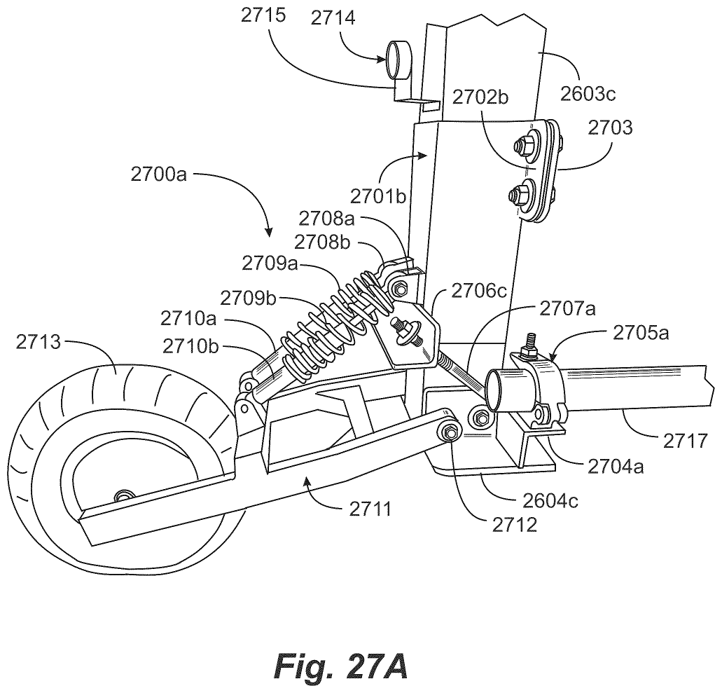

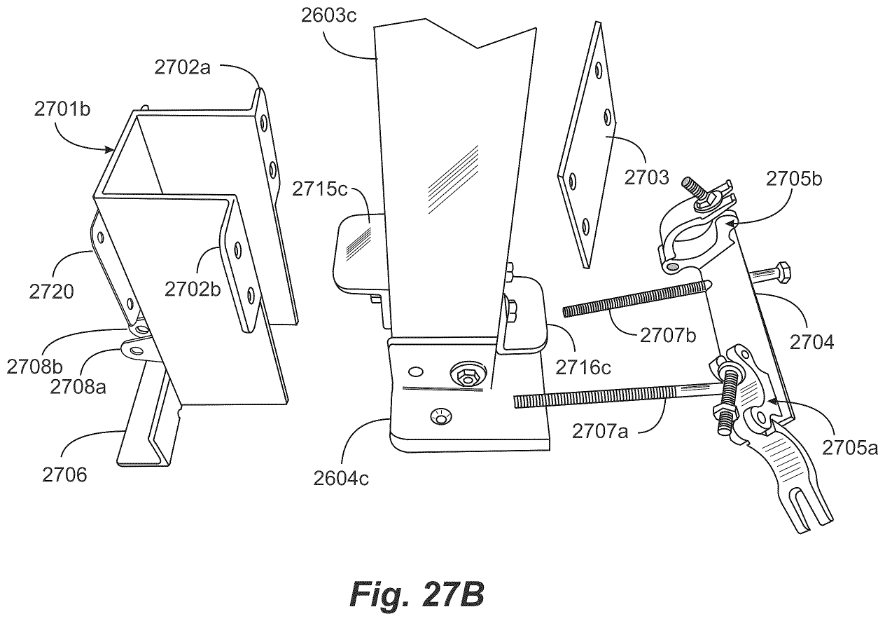

FIG. 27A is a side elevation view of post 2603c with added elements to provide a sturdy wheel assembly 2700a. The direction to the rear is to the left in FIG. 27A. An identical wheel assembly 2700b (not shown) is added to post 2603b to provide two wheels on one end of frame 2602 in a partial conversion to a street-legal trailer. When transformed into a street-legal trailer, posts 2603b and 2603c are on the trailing end of the towed apparatus.

Attachment of wheel assembly 2700a to post 2603c as seen in FIG. 27 is based on a three-sided weldment 2701b which is placed over post 2603c from the rear. Weldment 2701b is shown not engaged to the post in perspective view in FIG. 27B along with some other elements to mount weldment 2701b.

Two angle brackets that bolt to post 2603c to aid in mounting the wheel assembly are not seen in the assembly view of FIG. 27A, but are seen in FIG. 27B as angle brackets 2715c and 2716c. Bracket 2715c presents an upward-facing shoulder at a dimension above that of bracket 2716c, which presents a downward-facing shoulder near the lower extremity of post 2603. Weldment 2701b has an angle bracket 2706c welded across a lower extremity of the weldment and extending outwards on both sides, as seen in both FIG. 27A and FIG. 27B. When weldment 2701b is placed over post 2603c bracket 2706c rests on the upward-facing shelf of bracket 2715c. This circumstance positions weldment 2701b at a correct height on the post. Once in place weldment 2701b is partially secured by a plate 2703 to side brackets 2702a and 2702b of the weldment with conventional bolts and nuts in this example.

An angle bracket 2704a is provided with two holes through at about a 45 degree angle as seen in FIG. 27B and two lengthy bolts 2707a and 2707b pass through the two holes. The bolts pass up through similar angled holes in bracket 2706c welded to weldment 2701b as seen in FIG. 27A. Tightening nuts on these bolts draws bracket 2704 upward under bracket 2716 securely holding weldment 2701b down against the shelf of bracket 2715c, and weldment 2701b is thusly securely anchored to post 2603c.

Bracket 2704a has a first clamp 2705a and a second clamp 2705b securely fastened to bracket 2704, such as by welding. First clamp 2705a secures a long tube 2717 that is used to tie post 2603c to post 2603d in the front of the framework. Second clamp 2705b seen in FIG. 27B serves to secure a similar tube not see that ties post 2603c across the back of the framework to post 2603b on the opposite side. Clamps and posts are also incorporated to tie posts 2603a and 2603b together. These tubes clamped between posts in the trailer version of the framework provide strength and stability in transport.

A plate 2720 shown on weldment 2701b in FIG. 27B is sized and provided to mount a trailer license plate not shown in FIGS. 27A and 27B. Stop, tail lights and turn signal lights are also mounted to post 2603c or to the weldment, and conductors for operating the lights are passed through tube 2717 from the front of the framework when operated as a trailer.

As seen in FIG. 27A a forked frame 2711 is cantilever mounted to post 2603c by a pivot axle 2712 passing through foot 2604c and the post. Frame 2711 mounts a heavy-duty wheel 2713. Frame 2711 is joined to weldment 2701b in this embodiment by two shock absorbers 2710a and 2710b. Heavy-duty compression springs 2709a and 2709b are also implemented with the shock absorbers to provide an effective suspension system. A similar frame and wheel assembly are mounted at post 2603b so the trailer version has wheels on opposite sides of the rear of the trailer.

A tail-stop-turn-signal light 2714 is mounted on a bracket 2715 in a rear-facing portion of post 2603c. This light is conventional art and is wired through, in this example, tube 2717 to the front of the trailer and to a conventional electrical coupler on the rear of the towing vehicle, as is known in the art. A similar tail-stop-turn-signal light is mounted and wired to post 2603b on the other side of the rear of the trailer, so there are two such lights on the rear, as is conventional.

FIG. 28 is a perspective view of a front of the trailer from a corner of post 2603a. Post 2603a and 2503d are seen with feet 2604a and 2604d An I-beam 2801 is mounted at a height above the bottom of the posts with bolts at the sides of the posts through a clamp bracket 2802a and b behind each post. Bolt 2803a and clamp bracket 2802a are seen in FIG. 28.

Referring now to FIG. 27B, it was described above that two angle brackets 2715c and 2716c are bolted to post 2603c creating an upward and a downward facing shoulder. Similar brackets 2715a and 2716a are bolted to post 2603a, but only a portion of bracket 2715a is visible. Brackets 2715d and 2716d are also bolted to post 2603d, but not visible in FIG. 28. I-beam 2801 rests on the upward-facing shoulder of bracket 2715a and is pulled down against that shoulder by two bolts at a 45 degree angle down through bracket 2804a, which is placed under bracket 2716a, not seen. One angled bolt 2805a is seen. I-beam 2801 is anchored to post 2603d in the same way as described here for post 2603a. The I-beam is the main element that secures posts 2603a and 2603d together at the front of the trailer, creating a rigid assembly to withstand the forces experienced as a towed trailer on public roads. A clamp 2705 is seen secured to bracket 2804a clamping a tube 2717 along one side of the trailer between posts 2603a and 2603b.

A conventional trailer hitch 2806 is secured to an upper region of I-beam 2801 midway and extends forward. A road-worthy dolly 2807 is provided to carry the front of the apparatus as a trailer. Dolly 2807 has a sturdy frame 2808 with an upward-adjustable center post 2809 with a hitch ball 2810 at the top of the post. The frame 2808 has an axle 2811 presenting two wheels 2812a and 2812b to the sides of the frame. A second trailer hitch 2813 is implemented on a forward extension of the dolly frame. This trailer hitch is to join to a hitch ball of a towing vehicle such that the trailer version of the canopy apparatus may be towed on public roads.

From the above description is may be seen that a free-standing canopy appliance such as that depicted in FIG. 26 may be converted by addition of a fixed set of elements to a road-worthy and legal licensed trailer, and that the set of elements may be added to the free-standing canopy appliance whenever it is deemed necessary to move the appliance over public roadways to a different location, and that when the appliance is relocated, the set of elements may be removed to leave the free-standing appliance in place to serve its functions as an electricity generator or a carport or both.

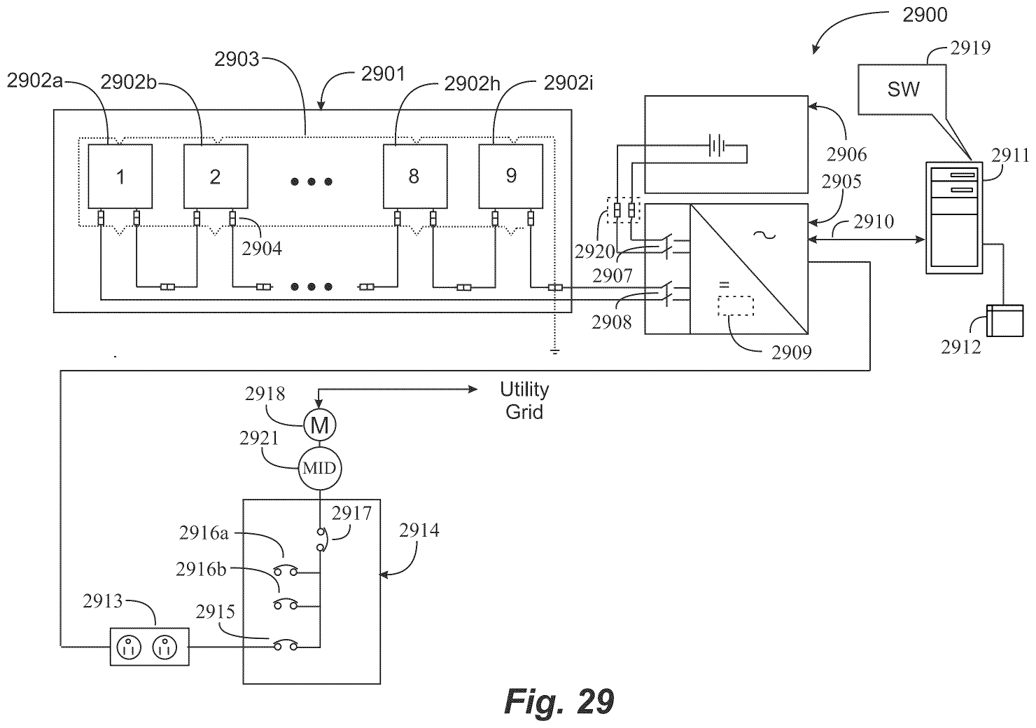

In another aspect of the invention a system is provided that comprises a free-standing canopy appliance having solar panels electrically interconnected and coupled to local equipment at a premise that enables selective powering of the premise, storing energy or feeding generated power into the local utility grid. FIG. 29 is a diagram of such a system in one embodiment of the present invention.

In system 2900 a free-standing canopy appliance 2901 has nine solar panels, numbered 1 through 9, and labeled as elements 2902a through 2902i mounted to a frame that in one embodiment is supported on four corner posts, and in use provides a canopy or carport as well as an electricity generating appliance. The solar panels are grounded along dotted lines 2903 and are interconnected and connected to an inverter 2905 through mating connectors 2904. Only one connector is labeled with an element number, but all mating connectors are shown. The electricity generated by the solar panels is provided to inverter 2905 Switches 2907 and 2908 serve as DC safety disconnect during abnormal operating conditions. In this example the inverter is a Sol-Ark hybrid inverter of 12 k output; 240V AC, 37.5 Amp. In other embodiments different inverters may be suitable. The solar panels in this example are Canadian Solar CS6W-540MB-AG bi-facial solar panels, but a variety of other panels may be used. The Canadian Solar CS6N-540MB-AG is a 540 W, bifacial, monocrystalline solar panel from the BiHiKu6 series, designed for utility-scale power plants and other applications. It features 144 half-cut cells and can produce up to 30% more power from its back side, while its main specifications include a maximum system voltage of 1500V, a temperature coefficient of −0.34% −0.34%/° C., and a 30-year linear power performance warranty.

A storage battery 2906, in this example made by Simplify Corporation, stores 6.65 KWh, and is connected to the inverter through a pair of remotely operable switches 2907. In other embodiments a battery or multiple batteries of other make and capacity may be used. Battery 2906 is joined to inverter 2905 by connectors 2920 so the battery may be removed and replaced. In one embodiment multiple batteries are interconnected by similar connectors.

Inverter 2905 supplies electrical power to local breaker panel 2914 through a 40 amp 2 pole breaker 2915. There may be one plug-in connection 2913 in the line from the inverter to the breaker panel. From the breaker panel various local premise loads are supplied through breakers such as breakers 2916a and 2916b in breaker panel 2914. There may be more loads than indicated. Breaker 2917 is the main 240V breaker in the breaker panel, and can be connected to a Microgrid Interconnect Device (MID) 2921 before connecting further with the bidirectional utility meter 2918, which is, in this example, 1-phase 3-W 120/240V meter.

MID 2921 safely connects and disconnects a home or microgrid from the utility grid and acts as the gateway between grid-tied and islanded operation, automatically detecting utility grid conditions and switching modes as needed by monitoring voltage, frequency, and power flow, and when the utility grid fails or becomes unstable, the MID isolates (islands) the microgrid to keep local loads powered. When the grid returns, it resynchronizes and reconnects safely, often communicating with PV inverters, batteries, and controllers often via Modbus or similar protocols to coordinate system behavior. In system 2900, inverter 2905 comprises a microprocessor 2909 operatively coupled to a data repository (not shown). The microprocessor 2909 is configured to communicate via an Internet connection with an Internet-connected server 2911, which is coupled to a data repository 2912. The server 2911 is hosted by an energy provider associated with the local premises of system 2900 and executes software (SW) 2919 configured to monitor energy consumption within the utility grid connected to the premises and to forecast anticipated energy demand.

In certain embodiments, system 2900 may interface with online services that enable an energy prosumer, such as the owner of a premises incorporating an embodiment of the invention to sell surplus generated energy back into the local utility grid. One such service is referred to as Virtual Power Purchase (VPP). Through such a service, the consumer may enter into a Virtual Power Purchase Agreement (VPPA), which constitutes a financial contract for renewable energy.

Under a VPPA arrangement, a buyer agrees to a price for renewable energy. Although no physical delivery of the electrical energy might occur, the buyer receives renewable energy attributes, such as Renewable Energy Certificates (RECs), together with a financial settlement determined by the difference between the fixed contract price and the prevailing wholesale market price. The renewable energy project sells the generated electricity into the wholesale market at the prevailing rate, and the buyer either pays or receives the difference between the contract price and the market price.

In certain embodiments of the invention, inverter 2905 and server 2911 cooperate to automate participation in such Virtual Power Purchase frameworks. Microprocessor 2909 may be configured to collect, timestamp, and transmit generation and consumption data from the local premises to server 2911, which in turn may securely communicate verified production data to one or more VPP or VPPA platforms. The server 2911 may further execute control algorithms that determine optimal times for energy export, curtailment, or storage based on real-time market prices and forecasted load conditions, thereby enabling the system 2900 to act as a node within a distributed Virtual Power Plant network.

In this manner, the described system not only manages local energy production and consumption but also facilitates economic participation in renewable energy markets, allowing the premises owner to derive both environmental and financial benefits from distributed generation assets.

In yet another embodiment, the system 2900 may include secure bidirectional communication capabilities with a VPPA clearinghouse or blockchain-based verification registry. In such embodiments, microprocessor 2909 may be configured to digitally sign and encrypt energy production data prior to transmission, ensuring data integrity and non-repudiation for financial settlement purposes. The clearinghouse or blockchain ledger may validate the authenticity of the transmitted data and issue corresponding digital tokens or renewable energy certificates (RECs) linked to verified kilowatt-hour outputs. Conversely, settlement information, contract performance data, or market price updates may be transmitted back to the local server 2911 to update internal accounting, reporting, or predictive optimization algorithms.

Such integration ensures transparent, auditable, and tamper-resistant documentation of renewable energy generation and associated financial transactions, thereby increasing trust among market participants and enabling seamless interoperability between physical generation assets and digital financial instruments in distributed energy ecosystems.

Another service is a Community Choice Aggregator (CCA), which is a program that allows local governments to buy and/or generate electricity on behalf of their residents and businesses. CCAs purchase electricity from a variety of sources, which can include a higher percentage of renewable energy, and allow communities to meet local climate goals and have more energy options. An existing electric utility continues to handle the physical delivery of electricity through the transmission and distribution lines, as well as services like meter reading, billing, and maintenance. A CCA aggregates the electricity demand for a community to purchase power in bulk, which can lead to lower rates or a greater focus on renewable energy sources. The CCA manages power procurement and can work with new energy suppliers, while the utility remains responsible for the grid's infrastructure and customer billing. Depending on the program, customers can choose to remain with the utility or opt into the CCA's energy supply plan. Some CCA programs may also offer a choice between different energy plans.

These services have an online presence, which in FIG. 29 may be represented by server 2911. Inverter 2905 with battery 2906 may communicate jointly or separately with the VPP or CCA server 2911 which orchestrates dispatching of the available amount of energy in the battery storage. Every consumer at a local premise like the premise served by system 2900 may configure through server 2911 how many kilowatt hours they want to retain for self-consumption and how much they want to offer for sale at peak demand hours. The VPP or CCA dispatch computer (Sever 2911) maintains a database of available and dispatchable kilowatt hours in distributed appliance batteries at local systems and is responsible for demand response, dispatch, pricing and billing. Advanced utilities may act directly performing the functions of the VPP/CCA.

Switches 2907 and 2908 associated with inverter 2905 and battery 2906 are required by safety regulations and disconnect the PV array during abnormal operating conditions.

System 2900 may operate in a first mode wherein electricity is wholly supplied by the local grid through meter 2918 and main breaker 2917 to supply loads connected to breakers 2916a and 2916b and perhaps other connected loads. A second mode may be canopy appliance 2901 providing all power to the local premise through inverter 2905 and junction box 2914, with perhaps main breaker 2917 open. In this mode with low or no premise load extra energy generated by canopy appliance 2901 is stored in battery 2906. If premise loads are greater than energy generated by canopy appliance 2901 the difference is supplied by battery 2906, and if battery 2906 is depleted, by the grid through main breaker 2917. A third mode for system 2900 may be wherein a part of the energy to the premise is provided by canopy 2901 and a part by the local grid. In this mode a balance is maintained according to changing loads, wherein energy may flow into or out of battery 2906 and energy may vary flowing from the grid through meter 2918. A fourth mode involves server 2911 managing inverter 2905 with battery 2906 to contribute power to the grid per any existing agreement between the host of server 2911 and the proprietor of the premise served by system 2900. In this mode the voltage output by inverter 2905 backed by battery 2906 is managed to be higher than that of the grid so there is a net current flow through meter 2918 into the grid.

A person of ordinary skill will understand that the embodiments described above are each and all exemplary and are not limiting to the scope of the invention, which is limited only by the claims. There are a variety of ways that different features of the invention may be implemented other than the specific ways disclosed in the examples illustrated and described. The scope is limited only by the claims.

1. A system comprising:
a free-standing electricity generating appliance having a frame in a rectangular aspect with a length a width and a height providing a canopy, the appliance having four corner posts, two forward and two rear, upper cross-members joining the corner posts, solar panels joined to individual ones of the upper cross-members, and circuitry and wiring interconnecting the solar panels;
an inverter connected to the interconnected solar panels;
one or more storage batteries connected to the inverter through remotely-operable switches;
a local breaker panel connected to an output of the inverter through a breaker, to a local electric grid through a main breaker, an optional Microgrid Interconnect Device (MID) and a two-way meter, and to loads of a local premise through breakers; and
an Internet connected server executing software and coupled to a data repository, hosted by a service configured to enter into agreements regarding power generation by the free-standing electricity generating appliance, the Internet-connected server coupled through the Internet network to the inverter;
wherein the Internet-connected server manages the inverter and storage battery combination according to an existing agreement, controlling the inverter and batteries to flow electricity through the two-way meter into the local grid.

2. The system of claim 1 wherein the Internet-connected server tracks current flow into the utility grid and stops the current flow through the meter into the utility grid according to the existing agreement.

3. The system of claim 1 further comprising the corner posts having a square cross section and each corner post fastened to and supported on a base plate with an area greater than the cross section of the corner post.

4. The system of claim 1 wherein the upper cross members of the frame form a rectangular top supporting three horizontal solar panels, two solar panels are hinged to cross members of each long side of the top, and one solar panel is hinged to cross members of each short side of the top, for a total of nine interconnected solar panels.

5. The system of claim 4 wherein the frame further comprises apparatus configured to support the six hinged solar panels in a horizontal aspect.

6. The system of claim 1 wherein the frame further comprises four removable wheel assemblies, one wheel assembly joined to a lowermost portion of each corner post, enabling the appliance to be rolled on the wheels.

7. The system of claim 1 wherein the solar panels are bifacial solar panels.

8. The system of claim 1, wherein the inverter is bidirectional and is configured to manage charge and discharge of the one or more storage batteries.

9. The system of claim 21, wherein the one or more storage batteries are removable, and are coupled through standardized connectors enabling portable and swappable energy storage.

10. The system of claim 1, wherein the Internet connected server is hosted by a service according to Virtual Power Plant (VPP) protocol, and the inverter is configured to receive and act upon remote dispatch instructions for (VPP) participation.

11. A method for powering a premise electrically, comprising:
providing a free-standing electricity generating appliance having a frame in a rectangular aspect with a length a width and a height providing a carport, the appliance having four corner posts, two forward and two rear, upper cross-members joining the corner posts, solar panels joined to individual ones of the upper cross-members, and circuitry and wiring interconnecting the solar panels;
connecting the interconnected inverter of the free-standing electricity generating appliance to a Microgrid Interconnect Device (MID) ;
connecting one or more storage batteries by connectors to the inverter through remotely-operable switches;
connecting output of the inverter to a local breaker panel through a breaker, to a local electric grid through a main breaker with a MID and a two-way meter, and to loads of a local premise through breakers; and
establishing communication between the inverter and an Internet connected server executing software and coupled to a data repository, hosted by a service configured to enter into agreements regarding power generation by the free-standing electricity generating appliance, the Internet-connected server coupled through the Internet network to the inverter, such that the Internet-connected server is enabled to manage the inverter and storage battery combination according to an existing agreement, controlling the remotely operable switches and the output voltage of the inverter to flow current through the two-way meter into the local grid.

12. The method of claim 10 comprising the Internet-connected server tracking current flow into the grid, and stopping the current flow through the meter into the grid according to the existing agreement.

13. The method of claim 10 further comprising providing the free-standing electricity generating appliance with the corner posts having a square cross section and each corner post fastened to and supported on a base plate with an area greater than the cross section of the corner post.

14. The method of claim 10 comprising providing the free-standing electricity generating appliance with the upper cross members of the frame forming a rectangular top supporting three horizontal solar panels, two solar panels hinged to cross members of each long side of the top, and one solar panel hinged to cross members of each short side of the top, for a total of nine interconnected solar panels.

15. The method of claim 14 comprising providing an apparatus configured to support the six hinged solar panels in a horizontal aspect.

16. The method of claim 10 comprising providing the frame with four removable wheel assemblies, one wheel assembly joined to a lowermost portion of each corner post, enabling the appliance to be rolled on the wheels.

17. The method of claim 10 comprising providing the solar panels as bifacial solar panels.

18. The method of claim 1, comprising providing the inverter as a bidirectional inverter configured to manage charge and discharge of the one or more storage batteries.

19. The method of claim 21, comprising providing the one or more storage batteries as removable, and coupling the batteries through standardized connectors enabling portable and swappable energy storage.

20. The method of claim 10, comprising hosting the Internet connected server by a service according to Virtual Power Plant (VPP) protocol, and configuring the inverter to receive and act upon remote dispatch instructions for (VPP) participation.
